(19) United States
(12) Patent Application Publication
(10) Pub. No.: US 2013/0274933 A1
(43) Pub. Date: Oct. 17, 2013

(54) GRID IMPROVEMENT METHODS

(71) Applicants: John F. Kelly, Elmhurst, IL (US); Gregory C. Rouse, Sarasota, FL (US)

(72) Inventors: John F. Kelly, Elmhurst, IL (US); Gregory C. Rouse, Sarasota, FL (US)

(21) Appl. No.: 13/918,983

(22) Filed: Jun. 16, 2013

Related U.S. Application Data
(63) Continuation-in-part of application No. 13/789,556, filed on Mar. 7, 2013.
(60) Provisional application No. 61/607,995, filed on Mar. 7, 2012.

(51) Int. Cl. G05F 3/04

(52) U.S. Cl. CPC G05F 3/04
USPC 700/286

(57) ABSTRACT

A grid performance improvement method including simultaneous use of selected indicia of performance in a performance assessment program.

### PRIORITY CLAIM AND INCORPORATION BY REFERENCE

This application is a continuation-in-part of U.S. patent application Ser. No. 13/789,556 filed Mar. 7, 2013 titled GRID IMPROVEMENT METHOD which claims the benefit of U.S. Prov. App. No. 61/607,995 filed Mar. 7, 2012 titled GRID IMPROVEMENT METHOD, both of which are incorporated herein in their entireties and for all purposes.

### BACKGROUND OF THE INVENTION

1. Field of the Invention

The invention relates to a process. In particular, the invention includes a method for improving the performance of an electric grid.

2. Discussion of the Related Art

While a functional, widely distributed electric grid is but one part of a nation's infrastructure, examples of a large nation-state that remains politically stable and economically prosperous without one are scarce. Grid improvement driven by carefully designed measures of grid performance is therefore a matter of national interest.

Although it is not the current situation, grid improvement should be driven by a broad spectrum of electric power industry stakeholders. These include generators, transmission companies, distributors, consumers, commercial entities, industry, electric industry suppliers of goods and services, and those affected by the activities and operations of any of these.

Indeed, historical standards for measuring grid performance reflect, to a large extent, the interests of the electric power industry. These grid performance measures therefore ignore significant non-industry interests. And, even when particular non-industry interests are recognized, these are often drowned out by unfair balancing against competing interests.

Although a general awareness of this problem has yet to develop, the writers find historical measures of grid performance fail to identify grid improvement initiatives that consider the broad spectrum of stakeholder interests. And, to the extent grid performance measures do identify and lead to non-capacity grid improvements, these initiatives have been sporadic and lack coordination on a large scale. Evidence of this singular vision of grid improvement is that since the grid's inception, grid capacity increases have persistently dominated grid investments. Grid performance measures other than those leading first and primarily to grid capacity improvements are needed.

### SUMMARY OF THE INVENTION

The present invention provides methods for improving electric grid performance. Embodiments utilize a rating system or performance assessment system (“PAP”) having standards and/or primary indicia of electric infrastructure performance. In various embodiments, performance against standards is evaluated using a plurality of criteria that are specific to each standard.

In an embodiment, a method of improving electric grid performance comprising the steps of: providing a governing body, a rating system, and certification candidates; the rating system incorporating a plurality of standards including enabling customer action, environment and efficiency, operational effectiveness, and reliability.

In an embodiment, a method of improving electric grid performance comprising the steps of: providing a performance assessment program (“PAP”), the PAP measuring means enabling customers to monitor and influence attributes of their electric service as a first primary indicia of performance, identifying electric system costs, wastes, and the value of improvements associated with particular electric system costs as a second primary indicia of performance, identifying source energy intensity and selected environmental effects as a third primary indicia of performance, and identifying duration and type of electric service interruptions as a fourth primary indicia of performance; providing a certifying authority, the certifying authority defining criteria for scoring each primary indicia of performance, the points to be awarded for meeting each criterion, and a minimum certifying score; providing certification candidates, each candidate operating at least one of electric generating facilities, electric transmission facilities, and electric distribution facilities; the certifying authority authorizing auditors to audit and score candidate performance using the PAP; conditioning the candidate's receipt of a certificate of registration on the candidate's PAP score; and, the certifying authority causing periodic publication of a list indicating electric industry participants holding certificates of registration.

### BRIEF DESCRIPTION OF THE DRAWINGS

The present invention is described with reference to the accompanying figures. These figures, incorporated herein and forming part of the specification, illustrate the present invention and, together with the description, further serve to explain the principles of the invention and to enable a person skilled in the relevant art to make and use the invention.

FIG. 1 shows a block diagram of the bulk electric grid.

FIG. 2 shows a block diagram of targeted revenue models.

### DETAILED DESCRIPTION OF THE PREFERRED EMBODIMENTS

The disclosure provided in the following pages describes examples of some embodiments of the invention. The designs, figures, and descriptions are non-limiting examples of certain embodiments of the invention. For example, other embodiments of the disclosed device may or may not include the features described herein. Moreover, disclosed advantages and benefits may apply to only certain embodiments of the invention and should not be used to limit the disclosed inventions.

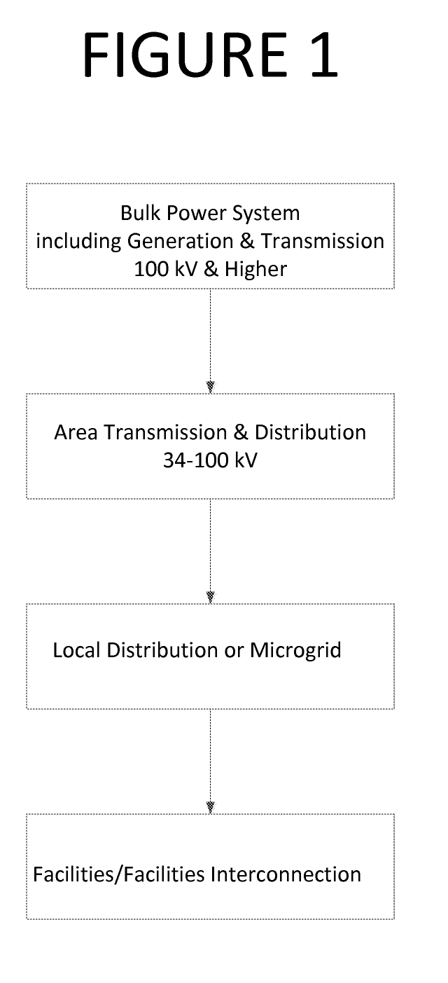

As shown in FIG. 1, electric industry infrastructure can be described as a hierarchy with the bulk power system (“the grid”) supplying electric power to area transmission and distribution, local distribution system or microgrid, and facilities.

The bulk power system as defined by the Regional Reliability Organization incorporates electrical generation resources, transmission lines, interconnections with neighboring systems and associated equipment and is generally operated at voltages of 100 kV or higher.¹ ¹ Glossary of Terms in the NERC Reliability Standards, page 8 of 51, http://www.nerc.com/docs/standards/rs/Reliability Standards Complete Set.pdf

Area transmission and distribution is an area wide power system generally operated between 34 kV and 100 kV and incorporates transmission, step-down transformers, area substations, and higher voltage area distribution, step down transformers and supply meters.

Microgrids generally include local distribution equipment. For example, microgrid equipment may include any or all of bulk power supply meter, substation, lower voltage distribution, breaker, switch, breaker/switch, load step-down transformer, and similar equipment. Microgrids are discussed further below.

Facilities include loads being supplied by the microgrid, including metering and sub-metering.

Distributed generation is defined as any generation that ties into the facility electricity system (downstream or in parallel with facility meter) or generation connected to the microgrid electricity system (downstream or in parallel with the microgrid supply meter). Distributed generation can include waste heat recovery in the form of steam, hot water, or chilled water that is supplied to local facilities.

Methods of this invention include grid improvement methods utilizing electric industry infrastructure data for purposes including performance evaluations. Any of fuel delivery systems, generating plants, area transmission and distribution, local distribution or microgrid, facilities, and the like can be rated. Moreover, embodiments utilize infrastructure data along with industry stakeholder data to enable complementary performance evaluations against standards including consumer enablement, environmental and efficiency, operational effectiveness, and reliability.

In various examples of rating systems or performance assessment programs (“PAP”) of the present invention, performance evaluations will include electric ratings for electric industry infrastructure near consumer interconnections such as local distribution and microgrid infrastructure involved in local distribution. Microgrids typically serve a specific constituent or set of consumers and consist of interconnected wires, distributed energy resources, and end-use loads for which metrics can be reported. Exemplary microgrid applications include municipalities, neighborhoods, universities and campuses of buildings, office parks, industrial parks, multiuse developments, and office towers.

In a microgrid electric delivery paradigm, the electricity delivery system includes a network of interactive and intelligent microgrids. Like traditional local distribution infrastructure, microgrids link customers with the bulk power systems. Unlike traditional local distribution infrastructure, microgrids incorporate extended functionality. In various embodiments, microgrids include automated adaptation to changing needs and conditions of the bulk power system. Therefore, microgrids are not only served by the bulk power grid, they also provide valuable services, such as demand-response functionality, to the bulk power grid.

Augmenting and working in concert with the bulk grid, intelligent microgrids offer reliable, uninterrupted electric power while enabling customers to participate as partners and providers in the electricity enterprise. Intelligent microgrids integrate local resources at the community level and allow both consumers and suppliers to take full advantage of the smart grid transformation. This also allows intelligent microgrids to immediately island to serve local needs when the bulk power system is lost or when local generation becomes advantageous such as economic advantage.

Performance metrics and system attributes are selected for the grid improvement methods (“GIM”) to work in conjunction with other ratings systems that focus at the building or facility level, such as ENERGY STAR and LEED. In addition, microgrids that purchase power from the bulk power system will need to obtain performance data for the GIM system metrics. This will require that the microgrid or local distribution company owners/operators gain access to the bulk power system performance data. In turn, the microgrid system owners/operators can require that suppliers provide the metrics and/or underlying data outlined in electricity distribution franchise and power purchase agreements.

The proposed GIM can be applied to different types of local distribution systems or microgrids, for example: 1) A microgrid where the owner/operator of the grid also owns/operates the buildings being served (e.g., universities; large multi-use towers, etc.); and, 2) A microgrid where the owner/operator of the grid does not own the buildings and facilities being served (municipality or local distribution company).

Intelligent microgrids focus on the local power delivery system, one that meets the needs of electric consumers. Microgrid based local power delivery systems of the present invention include microgrids that are manageable and accountable, enabling industry participants to partner with local government. Such partnerships enhance performance through, among other things, coordinated grid improvements and related infrastructure upgrades.

GIM include establishing a uniform rating system or performance assessment program (“PAP”) for businesses, consumers, and to encourage competition. In addition, GIM aim to educate stakeholders through increased awareness and to reveal gaps in performance. Grid performance metrics include customer engagement, operational effectiveness, reliability, and power supply or delivery energy efficiency and environment.

Customer Engagement/Enabling Customer Action—As information becomes more readily available customers are becoming more engaged in their purchasing and consumption—including electricity use. With increased demand and stress on the grid forecasted, customer engagement will be essential to achieving an improved electricity system. The intent of this category is to provide a defined set of performance criteria that demonstrate a consumer's ability to contribute to system improvement. The criteria in this category address measurable customer capabilities, standard processes and policies, programs and incentives that verify and increase customer contribution.

Operational Effectiveness—Consumers expect high-quality service from their electricity provider at competitive rates. The intent of this category is to provide a defined set of performance criteria that are common and available information to accurately represent the overall performance of a microgrid in terms of the operational efficiency, value produced, risk avoidance, and waste minimization. The criteria in this category address operational efficiency, quantifying value, and quantifying opportunity cost.

Reliability—To ensure that the quality of power and the safety of the public are not compromised in the quest for ever—cheaper energy, power reliability must be examined. The intent of this category is to provide a defined set of design and performance criteria that are common and available information to accurately represent the overall performance of a microgrid n terms of how reliably and safely the electricity they consume is generated, delivered, and used. The criteria in this category address sustained interruptions, momentary interruptions, ensuring power to key facilities/loads, reliability design attributes, power quality improvement, and risk mitigation.

Power Supply or Delivery/Energy Efficiency and Environment—Greater emphasis on improving power supply energy efficiency and environmental performance is called for and is a major oversight in the energy efficiency community. In addition, environmental responsibility is increasingly becoming an expectation for both companies and consumers in all sectors. The intent of this category is to define a set of performance criteria that are common and available information to accurately represent the overall performance of the electricity delivered and consumed by a microgrid in terms of energy efficiently and environmental stewardship. The criteria in this category address power supply energy efficiency, power supply air emissions, water consumption, power supply resource use, renewable energy credits, and design features.

The rating system uses five different criteria types to measure the performance of a grid:
1. Performance Outcome: Measureable performance against an industry benchmark or goal. This data is intended to promote and/or measure continuous improvement.
2. Demonstrated Capability: A measureable capability that supports achieving an ultimate customer outcome or supports efficient, safe, and reliable grid operation.
3. Performance Transparency: The measurement and aggregation of data with a defined starting point and a methodology for continued collection and trending.
4. Standard Process: A process that has recurrently demonstrated the ability to produce specific outcomes that supports efficient, safe, and reliable grid operation.
5. Design Consideration: A proven strategy or technology that provides a pathway to improved performance.

Known rating systems or standards tend to look narrowly, such as viewing one performance measure aspect at a time, i.e. reliability, or operational effectiveness, or one particular stakeholder. Embodiments of GIM provide for evaluating multiple performance measures and in cases these performance measures are evaluated from data gathered in a single bounded or limited time period.

A governing body manages the rating system. The governing body sets certification requirements, tracks certification metrics, and issues certifications to applicants. This body engages in various business endeavors and recoups costs incurred in carrying out its rating system creation and operation mission.

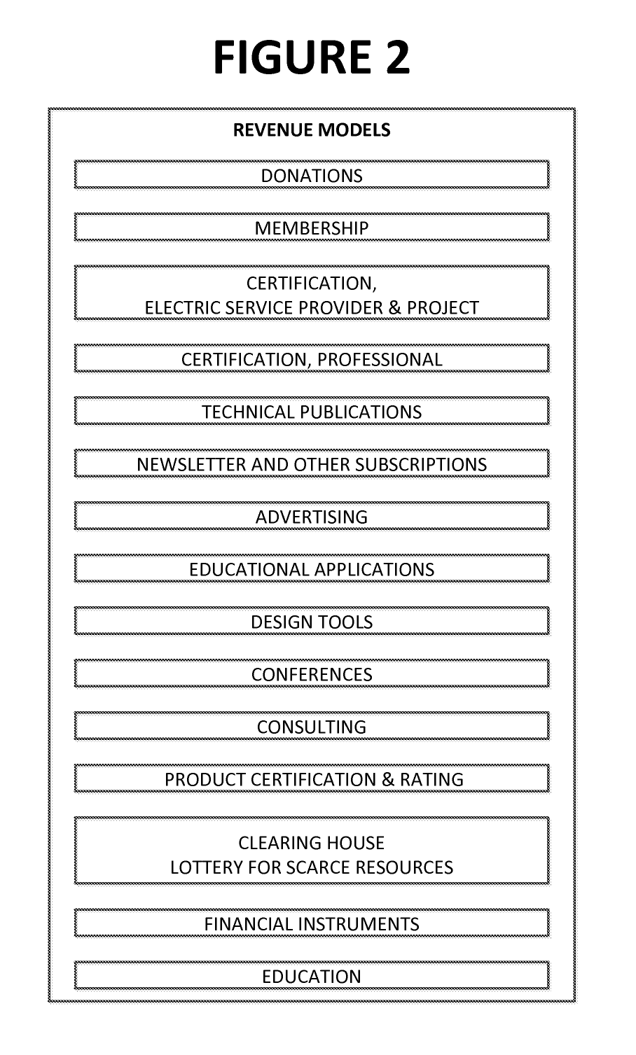

FIG. 2 shows targeted revenue models, any of which can be used alone or in combination to generate revenue. These revenue models are described below.

Donations are a first revenue source. The rating system governing body or board will seek donations from foundations and stakeholders including those with interests in issues addressed by the rating system. Donations may also come from customers and wealthy individuals. Methods of attracting donations include activities including communications such as:
a. Educational materials promoting the awareness of the rating system and the issues it is attempting to improve;
b. Contact and develop relationships with targeted donors; and,
c. Press release and email blast to targeted donors.

Membership is a second revenue source. This includes membership for organizations that want to join a user's group for the rating system but not membership in the governing body. The customer group for membership would be inclusive of all donors, project certification customers, professional certification customers, technology providers, regulators, attorney generals, government stakeholders, and the investment community. Methods for attracting customer memberships include activities including communications such as:
a. Members would get access to certain publications; and,
b. Discounts on products and services.

Project certification is a third revenue source. This would include revenue collected for certifying microgrids, projects, and utilities. Certification customers include universities, developers, corporations including Fortune 500 Corporations, petro and chemical plants, medical centers, military bases, and municipalities. Methods for attracting project certifications include activities including communications such as:
a. Pilot projects and case studies documenting the benefits; and,
b. Awards, competitions, and super bowls based on rating certified projects or projects under certification.

Professional certification is a fourth revenue source. Professional certification includes training for developers and designers of projects related to the rating system. Professional certification customers include individuals seeking professional certification, employees of the customers listed under Project Certification, as well as other interested parties such as consultants for these organizations, regulators, attorney generals and their staff, and technology providers. Class offerings will include understanding the rating system, understanding microgrids and the bulk power system, and developing/implementing strategies to improve microgrids and rating system scores. Methods for attracting professional certifications include activities including communications such as:
a. Pull from the project certification business which and organizations considering certification;
b. Pull created from conferences based on the rating system; and,
c. Pull from introductory classes and web based educational materials based on the rating system.

Technical publications are a fifth revenue source, for example sale of metrics handbooks and other publications. This would include revenue from books, guides, and other education materials related to explaining the rating system metrics and how to improve your score. This would also include documentation for certifying bodies and explanation of data entry codes such as what the American Medical Association provides doctors' offices and insurance companies. Additional publications would include comparative reports and case study details. Customers would be similar to the target membership group. Methods for attracting publication sales include activities including communications such as:
a. Certifiers will have to submit data using certain paper and web based forms requiring explanation form handbooks and other educational material; and,
b. Project managers and designers will need resources for improving designs and scores.

Newsletter and other subscriptions are a sixth revenue source. In addition to user group members and others may likely be interested in newsletter subscriptions and other documents related to the rating system. Topics for the newsletter would include upcoming changes or thinking around the rating, brief case studies, training materials, product reviews, and reports on user experiences. The target customer group here would be the same as the membership group. Methods for attracting newsletter and other subscription sales include email blasts, and advertisements through other products and services.

Advertising is a seventh revenue source. The governing body for the rating system will collect advertising revenue for advertisements in newsletters, other periodic publications, conference materials, websites, and apps. Customers include technology providers, certification consultants, and developments where the rating system has been applied. Methods of attracting advertising sales include upsells from targeted members and subscribers.

Educational “Apps” (applications for mobile devices such as smartphones and for non-mobile such as desktop computing devices) are an eighth revenue source. This would include revenue from educational smart phone applications and computer applications teaching consumers and stakeholder about the electricity system. Applications could include games; provide what-if scenarios or tools and resources for electricity consumers. Revenue could come from advertising as mentioned above or from sponsors such as museums and project developers. Customers include conference attendees, exhibit attendees, customers in special energy district and microgrid projects. Methods of attracting educational application revenues include user signs and posted website instructions offering application downloads to visitors.

Design tools are a ninth source of revenue. This includes revenue from sales of design tools to aid developers, designers, and planners for certification projects as well as developing projects that would eventually be certified by the rating system. Examples would include templates for failure modes and effects analysis and quality training tools. Customers include customers listed under project certification, professional certification and consultants. Methods of attracting design tool revenues include activities including communications such as:
a. Upsell from project certification, and professional certification;
b. Awareness form rating system conferences; and,
c. Advertising in rating system materials and classes.

Conferences are a tenth source of revenue. This would include revenue from conferences based around the rating system and training events. Customers would be drawn from all potential membership customers. Methods of attracting conference revenues include activities including communications such as:
a. Upselling from all products and services;
b. Embedded advertising in rating system materials; and,
c. Email database and blasts.

Consulting is an eleventh source of revenue. This includes consulting revenue from consulting for certifiers, parties undergoing the certification process, parties that are already certified but need to maintain their certification, and parties that are planning on certification. The governing body for the rating system will collect large amounts of data overtime which can be leveraged to help clients compare themselves to baselines and help them optimize their systems. This could include helping clients apply tools that they have already purchased and help provide technology providers design specifications. Customers include customers listed under project certification, professional certification and consultants. Methods for attracting email database and blast customers include activities including communications such as:
a. Upsell from project certification, and professional certification;
b. Awareness form rating system conferences; and,
c. Advertising in rating system materials and classes.

Product certification and product rating provides a twelfth source of revenue. In various embodiments this service utilizes information gained from verifying and tracking data and performance of systems with and without certification. In some embodiments members of the certifying body offer complementary certifications, ratings and standards development such as standards for interoperability and good design practice. Customers include technology providers, project certifiers, and those with professional certification. Methods of attracting product certification and product rating customers include activities including communications such as:
a. Reputation from successful projects; and,
b. Upselling from existing customers.

Clearing house or lottery for scarce resources represents a thirteenth source of revenue. Through experiences related managing the rating system and tracking the related data, the members of the certify body will likely become aware of scarce resources, such as clean distributed generation generators, or low cost clean energy suppliers and act a clearing house to connect these resources with interested customers. Customers include the customers listed under project certification, professional certification and consultants. Methods for attracting clearing house and lottery revenues include activities including communications such as:
a. Upselling to existing customers;
b. Customer websites and portals; and,
c. Consumer rating website for services offered.

Financial instruments are a fourteenth source of revenue. With experience from managing the rating system and tracking the related data, the certifying body members will become aware customer needs for financial resources and customer and/or customer group specific loan programs. Certifying body members working with banks and other financial institutions provide a means of developing these specialized loan programs and other customer resources. Customers include the customers listed under project certification, professional certification and consultants. Methods of attracting revenue through the use of financial instruments include activities including communications such as:
a. Upselling to existing customers;
b. Customer websites and portals; and,
c. Consumer rating website for services offered.

Education is a fifteenth source of revenue. Education media includes live classes, webinars, and educational materials such as printed and multimedia materials. These services may be offered to certifying professionals, non-certifying professionals, and others with an interest in the subject matter. Methods of attracting revenues through the use of education include activities including communications such as:
a. Educational programs;
b. Educational materials; and,
c. Educational certifications.

Here, and with other sources of revenue shown above, any one and any combination of the revenue attraction methods may be used. For example, early business stage funding sources may include and/or consist of combined revenues from memberships, project certifications, professional certifications, project consulting, and microgrid consulting.

Standards or primary indicia of performance used in the rating system include:
1. Customer Engagement/Enabling Customer Action;
2. Operational Effectiveness;
3. Reliability; and,
4. Power Supply or Delivery/Energy Efficiency and Environment.

As shown in the tables below, criteria that are specific to each standard provide a means of measuring performance against the standard, for example measuring performance and/or a change in performance such as improvement.

The criteria are associated not only with the standard(s) they measure but also with criteria types and scoring types. Criteria types include:
1. Demonstrated capability;
2. Design consideration;
3. Performance outcome;
4. Performance transparency; and,
5. Standard process.
   As skilled artisans will appreciate, the above list of criteria types may be expanded as, for example, extensions of the presently listed criteria types.

Scoring types include:
1. Prerequisite;
2. Core; and,
3. Bonus.
   As skilled artisans will appreciate, the above list of scoring types may be expanded as, for example, extensions of the presently listed scoring types.

In various embodiments, point values assigned to criteria provide a numerical basis for scoring performance against standards. And, in various embodiments each standard has a maximum point value determined by the governing body. Here, the governing body also determines one or more of standard specific certifying scores and/or an overall certifying score considering multiple standards.

Table 1 shows the criteria for each standard along with the scoring type and the criteria type.

TABLE 1
Standards, Criteria, Scoring Type & Criteria Type

| | | Scoring | |
|---|---|---|---|
| Standard | Criteria | Type | Criteria Type |
| Enabling | Advanced Metering | Prerequisite | Design |
| Customer | Infrastructure (“AMI”) | | Consideration |
| Action | | | |
| Enabling | Data Privacy | Prerequisite | Standard |
| Customer | | | Process |
| Action | | | |
| Enabling | Cyber Security | Prerequisite | Standard |
| Customer | | | Process |
| Action | | | |
| Enabling | Engagement Programs | Prerequisite | Design |
| Customer | | | Consideration |
| Action | | | |
| Enabling | Access to Real-time Data | Core | Standard |
| Customer | | | Process |
| Action | | | |
| Enabling | Access to Dynamic Pricing | Core | Standard |
| Customer | | | Process |
| Action | | | |
| Enabling | Home Energy Management | Core | Standard |
| Customer | Systems (“HEMS”) Choice | | Process |
| Action | | | |
| Enabling | Interconnection Standards | Core | Standard |
| Customer | | | Process |
| Action | | | |
| Enabling | Net Metering | Core | Standard |
| Customer | | | Process |
| Action | | | |
| Enabling | Electricity Supply Choice | Core | Standard |
| Customer | | | Process |
| Action | | | |
| Enabling | Renewable Generation | Core | Demonstrated |
| Customer | | | Capability |
| Action | | | |
| Enabling | Local Cleaner Power | Core | Demonstrated |
| Customer | Capability | | Capability |
| Action | | | |
| Enabling | Local Demand Response | Core | Demonstrated |
| Customer | Capability | | Capability |
| Action | | | |
| Enabling | Aggregation | Bonus | Standard |
| Customer | | | Process |
| Action | | | |
| Enabling | Financial Incentives | Bonus | Standard |
| Customer | | | Process |
| Action | | | |
| Enabling | Innovation | Bonus | Standard |
| Customer | | | Process |
| Action | | | |
| Environment | Renewable Portfolio | Prerequisite | Standard |
| and | Standard | | Process |
| Efficiency | | | |
| Criteria | | | |
| Environment | Local Air Permits | Prerequisite | Standard |
| and | | | Process |
| Efficiency | | | |
| Criteria | | | |
| Environment | Source Energy Intensity | Core | Performance |
| and | | | Outcome |
| Efficiency | | | |
| Criteria | | | |
| Environment | CO2 Intensity | Core | Performance |
| and | | | Outcome |
| Efficiency | | | |
| Criteria | | | |
| Environment | NOx Intensity | Core | Performance |
| and | | | Outcome |
| Efficiency | | | |
| Criteria | | | |
| Environment | SO2 Intensity | Core | Performance |
| and | | | Outcome |
| Efficiency | | | |
| Criteria | | | |
| Environment | Water Consumption | Core | Performance |
| and | | | Outcome |
| Efficiency | | | |
| Criteria | | | |
| Environment | Solid Waste Recycled | Core | Performance |
| and | | | Outcome |
| Efficiency | | | |
| Criteria | | | |
| Environment | Renewable Energy Credits | Bonus | Standard |
| and | | | Process |
| Efficiency | | | |
| Criteria | | | |
| Environment | District Energy | Bonus | Design |
| and | | | Consideration |
| Efficiency | | | |
| Criteria | | | |
| Environment | Local Renewables | Bonus | Design |
| and | | | Consideration |
| Efficiency | | | |
| Criteria | | | |
| Environment | Co-generation/CHP | Bonus | Design |
| and | | | Consideration |
| Efficiency | | | |
| Criteria | | | |
| Environment | Environmental Impacts | Bonus | Design |
| and | | | Consideration |
| Efficiency | | | |
| Criteria | | | |
| Environment | Innovation | Bonus | Performance |
| and | | | Outcome |
| Efficiency | | | |
| Criteria | | | |
| Operational | Local Improvement Plan | Prerequisite | Standard |
| Effectiveness | | | Process |
| Operational | Load Duration Curve | Core | Performance |
| Effectiveness | | | Outcome |
| Operational | Demand Reduction | Core | Demonstrated |
| Effectiveness | Capability | | Capability |
| Operational | Identify and Eliminate | Core | Standard |
| Effectiveness | Waste | | Process |
| Operational | Failure Identification and | Core | Standard |
| Effectiveness | Elimination | | Process |
| Operational | Electricity Energy Savings | Core | Performance |
| Effectiveness | | | Outcome |
| Operational | Local Generation Savings | Core | Performance |
| Effectiveness | | | Outcome |
| Operational | Demand Reduction Savings | Core | Performance |
| Effectiveness | | | Outcome |
| Operational | Reliability and Power | Core | Performance |
| Effectiveness | Quality (“PQ”) | | Outcome |
| | Value | | |
| Operational | Overall System Efficiency | Bonus | Performance |
| Effectiveness | | | Outcome |
| Operational | Ancillary Service Revenue | Bonus | Performance |
| Effectiveness | | | Outcome |
| Operational | Energy Waste Opportunity | Bonus | Performance |
| Effectiveness | Cost | | Outcome |
| Operational | Demand Reduction/Load | Bonus | Performance |
| Effectiveness | Profile Opportunity Cost | | Outcome |
| Operational | Reliability and PQ | Bonus | Performance |
| Effectiveness | Opportunity Cost | | Outcome |
| Operational | Operational Opportunity | Bonus | Performance |
| Effectiveness | Cost | | Outcome |
| Operational | Real-time Price | Bonus | Performance |
| Effectiveness | Opportunity Cost | | Outcome |
| Operational | Innovation | Bonus | Standard |
| Effectiveness | | | Process |
| Reliability | Communication Backbone | Prerequisite | Design |
| Criteria | | | Consideration |
| Reliability | Advance Meters | Prerequisite | Design |
| Criteria | | | Consideration |
| Reliability | SCADA | Prerequisite | Design |
| Criteria | | | Consideration |
| Reliability | Emergency Response Plan | Prerequisite | Design |
| Criteria | | | Consideration |
| Reliability | Safety Review of Design | Prerequisite | Standard |
| Criteria | Changes | | Process |
| Reliability | System Average | Core | Performance |
| Criteria | Interruption | | |
| | Duration Index (“SAIDI”)² | | Outcome |
| Reliability | System Average | Core | Performance |
| Criteria | Interruption Frequency | | Outcome |
| | Index (“SAIFI”) | | |
| Reliability | Customers Experiencing | Core | Performance |
| Criteria | Long Interruption | | Outcome |
| | Durations 5 | | |
| | (“CELID-5”) | | |
| Reliability | Average Service | Core | Performance |
| Criteria | Availability Index | | Outcome |
| | (“ASAI”) | | |
| Reliability | Damage and Exposure | Core | Design |
| Criteria | Prevention | | Consideration |
| Reliability | Island Capability | Core | Demonstrated |
| Criteria | | | Capability |
| Reliability | Alternative Source of | Core | Demonstrated |
| Criteria | Microgrid Supply | | Capability |
| Reliability | Critical or Key Loads | Core | Demonstrated |
| Criteria | | | Capability |
| Reliability | Power Resiliency for | Core | Demonstrated |
| Criteria | Essential Services | | Capability |
| Reliability | Distribution Redundancy & | Core | Demonstrated |
| Criteria | Automated Power | | Capability |
| | Restoration | | |
| Reliability | Upset Condition Risk | Core | Standard |
| Criteria | Mitigation | | Process |
| Reliability | Identify and Mitigate | Core | Standard |
| Criteria | Unforeseen Risks | | Process |
| Reliability | Momentary Average | Bonus | Performance |
| Criteria | Interruption Frequency | | Outcome |
| | Index (“MAIFI”) | | |
| Reliability | Customers Experiencing | Bonus | Performance |
| Criteria | Multiple Momentary | | Outcome |
| | Interruptions (“CEMMI-5”) | | |
| Reliability | Average Interruption | Bonus | Performance |
| Criteria | Frequency Index (“AIFI”) | | Outcome |
| Reliability | Distribution Redundancy | Bonus | Demonstrated |
| Criteria | and Auto Restoration | | Capability |
| Reliability | Power Quality Design | Bonus | Design |
| Criteria | Features | | Consideration |
| Reliability | Power Quality | Bonus | Performance |
| Criteria | Measurements | | Outcome |
| Reliability | Innovation | Bonus | Performance |
| Criteria | | | Outcome |

²Standard sustained interruption reliability indices include SAIDI, CAIDI, SAIFI, CAIFI, and ASAI.

The next three tables are sorted to show scoring types. In particular, Table 2 shows all of the criteria for the Prerequisite scoring type, Table 3 shows all of the criteria for the Core scoring type, and Table 4 shows all of the criteria for the Bonus scoring type.

TABLE 2
Prerequisite Scoring Type, Standard, Criteria & Criteria Type

| Standard | Criteria | Criteria Type |
|---|---|---|
| Enabling | Aggregation | Standard |
| Customer Action | | Process |
| Enabling | Financial Incentives | Standard |
| Customer Action | | Process |
| Enabling | Innovation | Standard |
| Customer Action | | Process |
| Environment and | Renewable Energy Credits | Standard |
| Efficiency | | Process |
| Criteria | | |
| Environment and | District Energy | Design |
| Efficiency | | Consideration |
| Criteria | | |
| Environment and | Local Renewables | Design |
| Efficiency | | Consideration |
| Criteria | | |
| Environment and | Co-generation/Combined Heat | Design |
| Efficiency | and Power (“CHP”) | Consideration |
| Criteria | | |
| Environment and | Environmental Impacts | Design |
| Efficiency | | Consideration |
| Criteria | | |
| Environment and | Innovation | Performance |
| Efficiency | | Outcome |
| Criteria | | |
| Operational | Overall System Efficiency | Performance |
| Effectiveness | | Outcome |
| Operational | Ancillary Service Revenue | Performance |
| Effectiveness | | Outcome |
| Operational | Energy Waste Opportunity | Performance |
| Effectiveness | Cost | Outcome |
| Operational | Demand Reduction/Load | Performance |
| Effectiveness | Profile Opportunity Cost | Outcome |
| Operational | Reliability and PQ | Performance |
| Effectiveness | Opportunity Cost | Outcome |
| Operational | Operational Opportunity Cost | Performance |
| Effectiveness | | Outcome |
| Operational | Real-time Price Opportunity | Performance |
| Effectiveness | Cost | Outcome |
| Operational | Innovation | Standard |
| Effectiveness | | Process |
| Reliability | MAIFI | Performance |
| Criteria | | Outcome |
| Reliability | CEMMI-5 | Performance |
| Criteria | | Outcome |
| Reliability | AIFI | Performance |
| Criteria | | Outcome |
| Reliability | Distribution Redundancy and | Demonstrated |
| Criteria | Auto Restoration | Capability |
| Reliability | Power Quality Design | Design |
| Criteria | Features | Consideration |
| Reliability | Power Quality Measurements | Performance |
| Criteria | | Outcome |
| Reliability | Innovation | Performance |
| Criteria | | Outcome |

TABLE 3
Core Scoring Type, Standard, Criteria & Criteria Type

| Standard | Criteria | Criteria Type |
|---|---|---|
| Enabling | Access to Real-time Data | Standard |
| Customer Action | | Process |
| Enabling | Access to Dynamic Pricing | Standard |
| Customer Action | | Process |
| Enabling | HEMS Choice | Standard |
| Customer Action | | Process |
| Enabling | Interconnection Standards | Standard |
| Customer Action | | Process |
| Enabling | Net Metering | Standard |
| Customer Action | | Process |
| Enabling | Electricity Supply Choice | Standard |
| Customer Action | | Process |
| Enabling | Renewable Generation | Demonstrated |
| Customer Action | | Capability |
| Enabling | Local Cleaner Power | Demonstrated |
| Customer Action | Capability | Capability |
| Enabling | Local Demand Response | Demonstrated |
| Customer Action | Capability | Capability |
| Environment and | Source Energy Intensity | Performance |
| Efficiency | | Outcome |
| Criteria | | |
| Environment and | CO2 Intensity | Performance |
| Efficiency | | Outcome |
| Criteria | | |
| Environment and | NOx Intensity | Performance |
| Efficiency | | Outcome |
| Criteria | | |
| Environment and | SO2 Intensity | Performance |
| Efficiency | | Outcome |
| Criteria | | |
| Environment and | Water Consumption | Performance |
| Efficiency | | Outcome |
| Criteria | | |
| Environment and | Solid Waste Recycled | Performance |
| Efficiency | | Outcome |
| Criteria | | |
| Operational | Load Duration Curve | Performance |
| Effectiveness | | Outcome |
| Operational | Demand Reduction Capability | Demonstrated |
| Effectiveness | | Capability |
| Operational | Identify and Eliminate Waste | Standard |
| Effectiveness | | Process |
| Operational | Failure Identification and | Standard |
| Effectiveness | Elimination | Process |
| Operational | Electricity Energy Savings | Performance |
| Effectiveness | | Outcome |
| Operational | Local Generation Savings | Performance |
| Effectiveness | | Outcome |
| Operational | Demand Reduction Savings | Performance |
| Effectiveness | | Outcome |
| Operational | Reliability and PQ Value | Performance |
| Effectiveness | | Outcome |
| Reliability | SAIDI | Performance |
| Criteria | | Outcome |
| Reliability | SAIFI | Performance |
| Criteria | | Outcome |
| Reliability | CELID-5 | Performance |
| Criteria | | Outcome |
| Reliability | ASAI | Performance |
| Criteria | | Outcome |
| Reliability | Damage and Exposure | Design |
| Criteria | Prevention | Consideration |
| Reliability | Island Capability | Demonstrated |
| Criteria | | Capability |
| Reliability | Alternative Source of | Demonstrated |
| Criteria | Microgrid Supply | Capability |
| Reliability | Critical or Key Loads | Demonstrated |
| Criteria | | Capability |
| Reliability | Power Resiliency for | Demonstrated |
| Criteria | Essential Services | Capability |
| Reliability | Distribution Redundancy & | Demonstrated |
| Criteria | Automated Power Restoration | Capability |
| Reliability | Upset Condition Risk | Standard |
| Criteria | Mitigation | Process |
| Reliability | Identify and Mitigate | Standard |
| Criteria | Unforeseen Risks | Process |

TABLE 4
Bonus Scoring Type, Standard, Criteria & Criteria Type

| Standard | Criteria | Criteria Type |
|---|---|---|
| Enabling | AMI | Design |
| Customer Action | | Consideration |
| Enabling | Data Privacy | Standard |
| Customer Action | | Process |
| Enabling | Cyber Security | Standard |
| Customer Action | | Process |
| Enabling | Engagement Programs | Design |
| Customer Action | | Consideration |
| Environment and | Renewable Portfolio Standard | Standard |
| Efficiency | | Process |
| Criteria | | |
| Environment and | Local Air Permits | Standard |
| Efficiency | | Process |
| Criteria | | |
| Operational | Local Improvement Plan | Standard |
| Effectiveness | | Process |
| Reliability | Communication Backbone | Design |
| Criteria | | Consideration |
| Reliability | Advance Meters | Design |
| Criteria | | Consideration |
| Reliability | Supervisory Control And Data | Design |
| Criteria | Acquisition (“SCADA”) | Consideration |
| Reliability | Emergency Response Plan | Design |
| Criteria | | Consideration |
| Reliability | Safety Review of Design | Standard |
| Criteria | Changes | Process |

Each of the standards and the related criteria are more fully explained in Appendix 1 of this patent specification.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A method of improving electric grid performance comprising the steps of:
providing a performance assessment program (“PAP”), the PAP measuring means for
enabling customers to monitor and influence attributes of their electric service as a first primary indicia of performance,
identifying electric system costs, wastes, and the value of improvements associated with particular electric system costs as a second primary indicia of performance,
identifying source energy intensity and selected environmental effects as a third primary indicia of performance, and
identifying duration and type of electric service interruptions as a fourth primary indicia of performance;
providing a governing body, the governing body defining criteria for scoring each primary indicia of performance, the points to be awarded for meeting each criterion, and a minimum certifying score;
providing certification candidates, each candidate operating at least one of electric generating facilities, electric transmission facilities, and electric distribution facilities;
the governing body authorizing auditors to audit and score candidate performance using the PAP;
conditioning the candidate's receipt of a certificate of registration on the candidate's PAP score; and,
the governing body causing periodic publication of a list indicating electric industry participants holding certificates of registration.

2. The grid improvement method of claim 1 wherein the audit includes evaluation of certification prerequisites including prerequisite design features and prerequisite standard processes.

3. The grid improvement method of claim 2 wherein prerequisite design features provide customers with advanced metering infrastructure, and engagement programs.

4. The grid improvement method of claim 2 wherein prerequisite design features include a communications backbone for gathering microgrid data, advanced meters. SCADA for gathering data and sending control signals to microgrid assets, and a power interruption emergency response plan.

5. The grid improvement method of claim 2 wherein prerequisite standard processes provide customers with energy data privacy and cyber security.

6. The grid improvement method of claim 2 wherein prerequisite standard processes include a local improvement plan including a master plan for electrical system upgrades, safety review of design changes protecting persons exposed to electrical hazards, renewable portfolio standards, and substantial compliance with local air permits.

7. The grid improvement method of claim 2 wherein the audit includes evaluation of core criteria types including core standard processes, core demonstrated capabilities, core performance outcomes, core performance transparencies, and core design features.

8. The grid improvement method of claim 7 wherein core standard processes include providing customers with access to real-time energy use data, access to dynamic electricity pricing, home energy management system (“HEMS”) choice, interconnection standards, net metering, and electricity supply choice.

9. The grid improvement method of claim 8 wherein core standard processes include identify and eliminate waste including inefficiencies in business operations, failure identification and elimination for the grid including distribution equipment, upset condition risk mitigation, and identify and mitigate unforeseen risks.

10. The grid improvement method of claim 7 wherein core demonstrated capabilities provide customers with renewable generation, local clean power generation, and local demand response capability.

11. The grid improvement method of claim 10 wherein core demonstrated capabilities include renewable generation, local clean power capability, local demand response capability, demand reduction capability, island capability, alternative source of microgrid supply, management of critical or key loads to increase reliability of power supply, power resiliency for essential services, and distribution redundancy and automated power restoration.

12. The grid improvement method of claim 7 wherein core performance outcomes include a specified improvement of load duration curve, SAIDI, SAIFI, CELID-5, ASAI, source energy intensity, CO2 intensity, NOx intensity, SO2 intensity, water consumption, and solid waste recycled.

13. The grid improvement method of claim 7 wherein core performance transparencies include tracking and reporting to customers electricity energy savings, local generation savings, and reliability along with power quality value.

14. The grid improvement method of claim 7 wherein core design features include damage and exposure prevention for outdoor grid equipment including overhead conductors and pad mounted equipment.

15. The grid improvement method of claim 2 wherein the audit includes evaluation of bonus criteria types including bonus standard process, bonus performance outcome, bonus performance transparency, bonus demonstrated capability, and bonus design features.

16. The grid improvement method of claim 15 wherein bonus standard processes include aggregation of customer electric loads and innovation for increasing customer participation including financial incentives, and renewable energy credits.

17. The grid improvement method of claim 15 wherein bonus performance outcomes include overall system efficiency increase.

18. The grid improvement method of claim 15 wherein bonus performance transparencies include ancillary service revenue, energy waste opportunity cost, demand reduction opportunity cost, load profile opportunity cost, reliability opportunity cost, power quality opportunity cost, operational opportunity cost, real-time price opportunity cost, and innovation.

19. The grid improvement method of claim 18 wherein bonus performance transparencies include MAIFI, CEMMI-5, AIFI, and selected power quality measurements.

20. The grid improvement method of claim 18 wherein performance outcome includes MAIFI, CEMMI-5, and AIFI.

21. The grid improvement method of claim 15 wherein bonus demonstrated capabilities include distribution redundancy and auto restoration.

22. The grid performance method of claim 15 wherein bonus design features include power quality management, district energy, local renewable generation, combined heating and power, and environmental impact management.

23. A method of improving electric grid performance comprising the steps of:
providing a performance assessment program (“PAP”) for certification candidates;
the PAP measuring candidate means for improving grid performance as indicated by primary indicia of performance;
providing a governing body that determines how the primary indicia of performance are evaluated;
conducting certification programs for candidates; and,
generating revenue from certification fees paid by candidates.

24. The grid performance improvement method of claim 23 wherein certification candidates include electric service providers.

25. The grid performance improvement method of claim 24 wherein certification candidates include grid improvement projects including microgrid projects.

26. The grid performance method of claim 25 wherein certification candidates include developers and designers of grid improvement projects including microgrid projects.

27. The grid performance improvement method of claim 26 wherein certification candidates include products to be certified and products to be rated.

28. The grid performance improvement method of claim 27 wherein professional certification candidates receive instruction on plural training modules including
microgrid technical training,
bulk power system technical training, and
PAP training; and,
wherein professional certification candidates are tested to assess their understanding of the PAP and grid improvement projects including microgrid projects.

29. The electric grid performance method of claim 23 further comprising revenues generated from PAP user group membership fees.

30. The electric grid performance method of claim 23 further comprising revenue generated from governing body approved conference and consulting services.

31. The electric grid performance method of claim 23 further comprising revenue generated from governing body approved publications including technical publications and newsletters.

32. The electric grid performance method of claim 31 further comprising revenue generated from advertisements placed in governing body approved publications.

33. The electric grid performance method of claim 23 further comprising revenue generated from governing body approved educational services and web supported educational applications including smartphone “apps.”

34. The electric grid performance method of claim 23 further comprising revenue generated from operation of a governing body approved clearing house for allocating scarce electric industry resources.

35. The electric grid performance method of claim 23 further comprising revenue generated from operation of a governing body approved lottery for allocating scarce electric industry resources.

36. The electric grid performance method of claim 23 further comprising revenue generated from financial instruments having governing body approval.

37. The electric grid performance improvement method of claim 23 further comprising revenue generated from governing body approved grid improvement software tools.
